(19) United States
(12) Patent Application Publication
(10) Pub. No.: US 2024/0425369 A1
(43) Pub. Date: Dec. 26, 2024

(54) SYSTEM AND METHOD FOR PYROLYSIS USING AN ELECTROMAGNETIC REACTOR

(71) Applicant: Acceleware Ltd., Calgary (CA)

(72) Inventors: Michal M. Okoniewski, Calgary (CA); Lynn P. Tessier, Eckville (CA); Ahmad Shazryz Azni, Calgary (CA); Apostolos Kantzas, Calgary (CA)

(21) Appl. No.: 18/829,873

(22) Filed: Sep. 10, 2024

Related U.S. Application Data
(63) Continuation of application No. PCT/CA2023/050318, filed on Mar. 10, 2023.
(60) Provisional application No. 63/319,058, filed on Mar. 11, 2022.

(51) Int. Cl. C01B 3/24; B01J 6/00

(52) U.S. Cl. CPC C01B 3/24; B01J 6/005; C01B 2203/0272; C01B 2203/0833; C01B 2203/085; C01B 2203/0855; C01B 2203/1241

(57) ABSTRACT

Systems and methods of generating hydrogen are described herein. The systems include a first reactor that receives a feed stream comprising a hydrocarbon gas and produces a pyrolysis product stream comprising hydrogen gas and solid carbon. The first reactor includes a series of high-frequency solenoid coils surrounding a first reactor chamber housing a molten material. The first reactor chamber is configured to direct the feed stream through the molten material to convert at least a portion of the hydrocarbon gas to hydrogen gas and produce a hydrogen gas product stream and a carbon product stream. The systems also include a second reactor that receives the hydrogen gas product stream. The second reactor houses a heated metal structure in a second reactor chamber configured to direct the hydrogen gas product stream through the heated metal structure to convert at least a portion of the hydrogen gas product stream to hydrogen gas.

### RELATED APPLICATIONS

The present application is a continuation of Internation Application No. PCT/CA2023/050318 filed Mar. 10, 2023, which claims priority from U.S. Provisional Patent Application 63/319,058 entitled System and Method for Pyrolysis Using an Electromagnetic Reactor” filed Mar. 11, 2022, the entire contents of which are hereby incorporated by reference herein.

### TECHNICAL FIELD

This disclosure generally relates to systems and methods for generating hydrogen gas and, more specifically, to systems and methods for generating hydrogen gas via pyrolysis using molten materials and micro arcing in an electromagnetic reactor.

### BACKGROUND

Hydrogen gas (H₂) is commonly produced from natural gas via steam methane reforming and is commonly used to produce commodity chemicals and as fuel. In the production of hydrogen gas by steam methane reforming, carbon dioxide (CO₂) is also produced as a byproduct. New methods of producing hydrogen gas are needed where harmful chemicals, such as but not limited to CO₂, are not produced.

Light hydrocarbon gas (primarily methane) pyrolysis can be used to generate hydrogen gas and solid carbon concurrently from the breaking down of the carbon-to-hydrogen bonds in the molecules. The reaction is CH₄ (g)↔2H₂ (g)+C (s), and it is highly endothermic with overall enthalpy of 74.8 kJ/mol at equilibrium. The biggest obstacle of methane decomposition is the high activation energy (312 to 450 kJ/mol) of the reaction, which requires the reaction to be in the range of 1,000° C. to 1,200° C. Catalysts such as nickel, cobalt and iron are commonly used in the reaction as the metals can reduce the reaction temperature down to 600° C.-900° C. range, as the catalysts decrease the reaction's activation energy. Due to the endothermic nature of methane pyrolysis, reaction temperature plays a vital role in maximizing methane conversion and reaction kinetics. The higher the reaction temperature, the higher the reaction rates and the higher the methane conversion to hydrogen gas and carbon. Besides that, according to Le Chatelier's principle, the reaction equilibrium will be shifted to the product side and ultimately promote methane conversion at low pressure as there is more hydrogen gas than methane in the reaction.

The methane pyrolysis using molten material as a heat transfer agent (be it metal or non-metal, e.g., salt and with or without catalytic properties) on an industrial scale might present many challenges, mainly the difficulty to heat a large volume of molten material to the reaction temperature while maintaining even temperature distribution throughout the reactor volume.

Pyrolysis, or the thermochemical decomposition of hydrocarbons, offers potential for generating hydrogen gas because it can be performed in an inert environment, typically at temperatures ranging between 300° C. and 1,200° C. In some examples of pyrolytic processes, hydrogen gas can be produced from the decomposition of methane. This process generally emits few greenhouse gases (GHGs) because the decomposition of methane to hydrogen gas yields only solid carbon and, notably, does not produce CO₂.

Current methods that directly decompose hydrocarbons produce large amounts of solid carbon and require high reaction temperature. Many strategies have been developed highlighting and assessing the methane decomposition technologies using solid catalysts, including metals, metal enhanced carbons, and activated carbons. The conclusions lead to the rapid deactivation of solid catalysts, which requires catalyst reaction and the high-power requirements and low pressures of hydrogen gas produced in plasma-type systems. For example:
U.S. Pat. No. 9,061,909 discloses the simultaneous production of carbon nanotubes and hydrogen from a hydrocarbon source. The carbon nanotubes are produced on the solid catalyst support and are removed from the support by a separation gas.
U.S. Pat. No. 6,936,234 discloses a process for converting methane to solid graphitic carbon without a catalyst in a high-temperature process at 2,100-2,400° C. The methods of heating and/or removing the carbon are not disclosed.
U.S. Pat. No. 9,776,860 discloses a process to decompose methane into graphitic powder and hydrogen employing a catalyst-free cycle in which a secondary chemical is recycled and reused.
Contacting methane with molten metals to produce solid carbon and hydrogen was described previously by W. Xia et al. in Energy & Fuels 2003, 17, pgs. 705-713. This work used molten tin and molten tin with suspended silicon carbide particles as the reaction environment. The authors report that the thermochemical process has increased methane conversion due to increased residence time when the particles are added to the tin melt in a non-catalytic heat transfer media.
More recently, molten tin was again utilized as a reaction medium for methane pyrolysis, Int. J. Hydrogen Energy 40, 14134-11146 (2015), with the metal serving as a non-catalytic heat transfer medium, allowed the solid carbon product to be separated from the gas phase hydrogen.
Upham et al. conducted an experimental study on methane pyrolysis in molten alloy system where active metals (Ni, Pt, Pd) with very high melting point are dissolved in inactive low-melting temperature metals (In, Ga, Sn, Pb) which shows that the active metals are atomically dispersed in the molten alloys.
U.S. Pat. No. 5,767,165 discloses continuous carbon removal from hydrocarbon decomposition reactions in molten media, where methane is fed to a bubble column of liquid tin. Therein, methane decomposes to carbon and hydrogen, and the carbon floats to the surface, where it can be removed.
Carbon produced from the thermal decomposition of hydrocarbons has also been shown to dissolve in the molten media in which the decomposition occurs. For example, U.S. Pat. No. 4,574,714 discloses the decomposition of organic waste into a molten metal bath. Oxygen is added, and the produced carbon is partially dissolved in the melt.
U.S. Pat. App. Pub. No. 2021/0380407 discloses a system for hydrogen gas production for local distribution, consumption, and/or storage. The system includes a pyrolysis reactor using molten metal as heat transfer media to convert the hydrocarbon into an output containing hydrogen gas and carbon particulates.
W.O. Pat. App. No. 2021/161192 discloses a method using liquid salt to separate the produced carbon from the methane pyrolysis in the molten metal reactor.
U.S. Pat. No. 7,563,525 discloses a method of hydrogen production from methane decomposition in an electric reaction technology system. The electric reaction system comprises of heating screens to pyrolyse the hydrocarbon gas into hydrogen gas and carbon.

Accordingly, there is a need for improved systems and methods of producing hydrogen that occur in an anaerobic environment that do not lead to the deactivation of the catalyst and extend the catalyst's usability lifetime.

### SUMMARY

In accordance with a broad aspect, a system for generating hydrogen is described. The system includes a first reactor configured to receive a feed stream comprising a hydrocarbon gas and produce a pyrolysis product stream comprising hydrogen gas and solid carbon. The first reactor includes of a series of high-frequency solenoid coils surrounding a first reactor chamber housing a molten material. The first reactor chamber is configured to direct the feed stream through the molten material to convert at least a portion of the hydrocarbon gas to hydrogen gas, carbon and residual hydrocarbons to produce a hydrogen gas product stream and a carbon product stream. The system also includes a second reactor configured to receive the hydrogen gas product stream. The second reactor houses a heated metal structure in a second reactor chamber. The second reactor chamber is configured to direct the hydrogen gas product stream through the heated metal structure to convert at least a portion of the hydrogen gas product stream to hydrogen gas.

In at least one embodiment, the reactors operate at a temperature in a range between about 300° C. and 1600° C.

In at least one embodiment, the temperature of the hydrogen, carbon and residual hydrocarbons leaving the reactors is in the range of about 300° C. to about 1600° C.

In at least one embodiment, the system also includes utilizing heat generated from the reactors to heat the hydrocarbons gas feed stream entering the pyrolysis generator.

In at least one embodiment, the hydrocarbon gas feed stream is preheated by the heat generated from the reactors to a temperature in the range of about 300° C. to about 500° C.

In at least one embodiment, the heat generated from the generators is used to preheat the inlet hydrocarbon gas stream by flowing the hydrocarbon gas into a heat exchanger and flowing the heated hydrogen gas, carbon and residual hydrocarbon gas from the pyrolysis product stream through the heat exchanger to heat the additional incoming gas.

In at least one embodiment, the hydrocarbon gas is methane or any light hydrocarbon gas.

In at least one embodiment, the heated hydrogen, carbon and residual hydrocarbon from the hydrocarbon product stream are passed through a gas separator to remove some or all of the carbon produced from the pyrolysis process.

In at least one embodiment, the first reactor includes at least a metal tube housing the molten material, the metal tube having a lower end and an upper end, the hydrocarbon feed stream passing from the lower end to the upper end.

In at least one embodiment, the molten material comprises a reactive component comprising a solid disposed within a molten salt mixture, and wherein the active component comprises a metal, a metal carbide, a metal oxide, a metal halide, solid carbon, or any combination thereof.

In at least one embodiment, the reactive component comprises Ni, Fe, Co, Ru, Ce, or any combination thereof.

In at least one embodiment, the molten salt mixture in which the solid dissolves comprises Ga, Bi, Sn, or any combination thereof.

In at least one embodiment, the first reactor includes a series of tubes that are electrically conductive and connected to an electrical source, the electrical source being configured to supply an electrical current to the series of tubes to heat the molten material therein as the hydrocarbon feed stream passes through the molten material.

In at least one embodiment, each tube of the series of tubes comprises a refractory metal.

In at least one embodiment, each tube of the series of tubes comprises one or more ceramics having either a high loss tangent or being electrically conductive.

In at least one embodiment, each tube of the series of tubes is arranged so that the upper end of each tube provides for carbon to be entrained by overflowing molten.

In at least one embodiment, the lower end of the tube is connected to an external source of molten material.

In at least one embodiment, the second reactor includes a series of metal structures that are electrically conductive and connected to an electrical source or a microwave source or an RF source, the electrical source or the microwave source or the RF source being configured to supply an electrical current and voltage to the series of metal structures to heat the series of metal structures as the hydrogen gas product stream passes through the series of metal structures.

In at least one embodiment, the metal structures are each a metal mesh comprising one or more high dielectric constant ceramics to promote micro arcing.

In at least one embodiment, the metal structures are covered with a high dielectric constant ceramic to facilitate dielectric breakdown and protect the metal structure.

In at least one embodiment, the system also included a series of electrodes arranged such that a dominant electric field is perpendicular to the metal structures and the electrodes are spaced to excite the electric field between them.

In at least one embodiment, the electrical current is a high-frequency current, such that the high frequency provides enough electrical loss to heat the metal.

In at least one embodiment, the RF signal can be modulated with envelope in acoustic or ultrasound frequency range that can induce mechanical vibration between the meshes to clean the surfaces periodically or continuously from the deposited carbon.

In at least one embodiment, at least a portion of the series of metal meshes comprises one or more surface features to enhance micro-arcing.

In at least one embodiment, the surface feature is a serrated edge or undulated with varying thickness to concentrate the electric field in specific locations.

In at least one embodiment, the electrical current can be modulated to control overall temperature and arcing conditions and assure varying locations of micro-arcs.

In at least one embodiment, the high dielectric constant ceramic comprises at least one of alumina, zirconia, BaSmTi, ZrTi, TiO₂, BaCaZrTi, BaSrTi, and BaTi.

In accordance with another broad aspect, a method of generating hydrogen is described herein. The method includes directing a feed stream comprising methane and/or other hydrocarbons into a first reactor. The first reactor includes of a series of high-frequency solenoid coils surrounding a first reactor chamber housing a molten metal. The first reactor chamber is configured to direct the feed stream through the molten metal to convert at least a portion of the methane and/or other hydrocarbons to hydrogen gas and residual hydrocarbons to produce a hydrocarbon product stream comprising the hydrogen gas and residual hydrocarbons. The method also includes directing the hydrocarbon product stream into a second reactor. The second reactor is configured to receive the hydrocarbon product stream. The second reactor houses a heated metal structure in a second reactor chamber, the second reactor chamber being configured to direct the hydrocarbon product stream through the heated metal structure to convert at least a portion of the residual hydrocarbons to hydrogen gas.

These and other features and advantages of the present application will become apparent from the following detailed description and the accompanying drawings. It should be understood, however, that the detailed description and the specific examples, while indicating preferred embodiments of the application, are given by way of illustration only, since various changes and modifications within the spirit and scope of the application will become apparent to those skilled in the art from this detailed description.

### BRIEF DESCRIPTION OF THE DRAWINGS

For a better understanding of the various embodiments described herein and to show more clearly how these various embodiments may be carried into effect, reference will be made, by way of example, to the accompanying drawings, which show at least one example embodiment, and which are now described. The drawings are not intended to limit the scope of the teachings described herein.

FIG. 1 is a schematic diagram of a system for generating hydrogen, according to at least one embodiment described herein.

FIG. 2 is a schematic diagram of another system for generating hydrogen, according to at least one embodiment described herein.

FIG. 3 is a schematic diagram of another system for generating hydrogen, according to at least one embodiment described herein.

FIG. 4 is a schematic diagram of another system for generating hydrogen, according to at least one embodiment described herein.

FIG. 5 is a schematic diagram of another system for generating hydrogen, according to at least one embodiment described herein.

FIG. 6A is a schematic diagram of an arrangement of solenoid tubes of a system for generating hydrogen, according to at least one embodiment described herein.

FIG. 6B is a schematic diagram of another arrangement of solenoid tubes of a system for generating hydrogen, according to at least one embodiment described herein.

FIG. 7 is another schematic diagram of a series of tubes, each housing a molten material, of a system for generating hydrogen, according to at least one embodiment described herein.

FIG. 8 is another schematic diagram of a series of tubes, each housing a molten material, of a system for generating hydrogen, according to at least one embodiment described herein.

FIG. 9 is a front perspective view of an arrangement of tubes within a first reactor of a system for generating hydrogen, according to at least one embodiment described herein.

FIG. 10 is a front view of a first reactor of a system for generating hydrogen, according to at least one embodiment described herein.

FIG. 11 is a front view of a third reactor of a system for generating hydrogen, according to at least one embodiment described herein.

FIG. 12 is a front view of a series of electrodes of a third reactor of a system for generating hydrogen, according to at least one embodiment described herein.

Further aspects and features of the example embodiments described herein will appear from the following description taken together with the accompanying drawings.

### DETAILED DESCRIPTION

Various apparatuses, methods and compositions are described below to provide an example of at least one embodiment of the claimed subject matter. No embodiment described below limits any claimed subject matter, and any claimed subject matter may cover apparatuses and methods that differ from those described below. The claimed subject matter is not limited to apparatuses, methods and compositions having all of the features of any one apparatus, method or composition described below or to features common to multiple or all of the apparatuses, methods or compositions described below. It is possible that an apparatus, method, or composition described below is not an embodiment of any claimed subject matter. Any subject matter that is disclosed in an apparatus, method or composition described herein that is not claimed in this document may be the subject matter of another protective instrument, for example, a continuing patent application, and the applicant(s), inventor(s) and/or owner(s) do not intend to abandon, disclaim, or dedicate to the public any such invention by its disclosure in this document.

Furthermore, it will be appreciated that for simplicity and clarity of illustration, where considered appropriate, reference numerals may be repeated among the figures to indicate corresponding or analogous elements. In addition, numerous specific details are set forth in order to provide a thorough understanding of the example embodiments described herein. However, it will be understood by those of ordinary skill in the art that the example embodiments described herein may be practiced without these specific details. In other instances, well-known methods, procedures, and components have not been described in detail so as not to obscure the example embodiments described herein. Also, the description is not to be considered as limiting the scope of the example embodiments described herein.

It should be noted that terms of degree such as “substantially,” “about,” and “approximately” as used herein mean a reasonable amount of deviation of the modified term such that the end result is not significantly changed. These terms of degree should be construed as including a deviation of the modified term, such as 1%, 2%, 5%, or 10%, for example, if this deviation does not negate the meaning of the term it modifies.

Furthermore, the recitation of any numerical ranges by endpoints herein includes all numbers and fractions subsumed within that range (e.g. 1 to 5 includes 1, 1.5, 2, 2.75, 3, 3.90, 4, and 5). It is also to be understood that all numbers and fractions thereof are presumed to be modified by the term “about,” which means a variation up to a certain amount of the number to which reference is being made, such as 1%, 2%, 5%, or 10%, for example, if the end result is not significantly changed.

It should also be noted that, as used herein, the wording “and/or” is intended to represent an inclusive-or. That is, “X and/or Y” is intended to mean X, Y or X and Y, for example. As a further example, “X, Y, and/or Z” is intended to mean X or Y or Z or any combination thereof. Also, the expression of A, B and C mean various combinations, including A; B; C; A and B; A and C; B and C; or A, B and C.

The following description is not intended to limit or define any claimed or as yet unclaimed subject matter. Subject matter that may be claimed may reside in any combination or sub-combination of the elements or process steps disclosed in any part of this document, including its claims and figures. Accordingly, it will be appreciated by a person skilled in the art that an apparatus, system, or method disclosed in accordance with the teachings herein may embody any one or more of the features contained herein and that the features may be used in any particular combination or sub-combination that is physically feasible and realizable for its intended purpose.

Recently, there has been a growing interest in developing new systems and methods of generating hydrogen gas.

Herein, systems and methods for generating hydrogen are described. The systems and methods generally provide for transforming hydrocarbons (i.e., molecules comprised primarily of carbon and hydrogen atoms) to hydrogen molecules (H₂) and elemental carbon (also referred to herein as solid carbon), which can be sequestered without the emission of carbon dioxide to the atmosphere.

In at least one embodiment, the systems and methods described herein improve on previous attempts to efficiently heat molten metals and salts in a reactor vessel. The reactor vessel has refractory tubes and high-frequency sources to convert gases containing carbon and hydrogen atoms into chemicals, including hydrogen gas and solid carbon. In at least one embodiment, the solid carbon can be removed from the reactor carried by the molten materials in a low cost and efficient manner.

In at least one embodiment, the systems and methods described herein include an electromagnetic reactor to heat molten materials present inside refractory tubes at a reaction temperature and maintain the molten materials, acting as a heat transfer media, at the reaction temperature to generate hydrogen gas and solid carbon from the light hydrocarbon pyrolysis without producing carbon dioxide. The various embodiments include continuous processes whereby carbon is produced from natural gas and separated from the molten media together with gas-phase chemical co-products and reactors and methods for carbon removal. In some embodiments, methane or other light hydrocarbon gases are fed into molten materials in refractory tubes, heated using high radiofrequency (RF). The reaction is endothermic, and heat is provided to the reactor via the high RF source through the molten materials in the refractory tubes.

In at least one embodiment, the systems and methods described herein may overcome barriers hindering prior approaches to transforming molecules containing carbon and hydrogen into solid carbon and chemical products and/or heat energy without producing any carbon dioxide using the molten material as heat transfer. Using refractory tubes and RF sources, as described herein, the molten materials can be heated evenly with greater power and energy efficiency. Commonly, reactors that use molten materials as heat transfer agents utilize a large body of molten material with conventional heating sources (e.g., natural gas furnace and electrical heating). Challenges of using a large body of molten materials include the difficulty of quickly heating the molten material at the desired temperatures and maintaining the desired temperatures evenly throughout the molten material. The processes and systems disclosed herein can overcome this issue as the RF source can quickly heat the refractory tube and the molten material therein; due to the smaller volume of the molten materials relative to other existing systems, the heat can be evenly and homogenously distributed to sustain the reaction.

In at least one embodiment, the systems and methods described herein may also overcome an issue of the feed stream not being fully converted to the desired chemical. This challenge may be overcome by coupling an RF molten material reactor with one or more heated mesh reactors that perform pyrolysis of unconverted methane and other light hydrocarbons present in a product gas from the RF molten material reactor. The mesh, which may be made up of catalytic or non-catalytic materials with serrated surfaces to increase the surface area exposed to the feed gas, is connected to electrical sources, promoting micro arcing, and decomposing the residual feed gas.

In at least one embodiment, the systems and methods described herein include providing a feed stream comprising a hydrocarbon into a reaction vessel and reacting the feed stream in the vessel to produce a solid carbon stream and a gas product stream. Reacting the feed stream in the vessel may include contacting of the feed stream with molten material, separating a gas produced from the molten material, and separating a solid carbon produced from the molten material. The reaction vessel comprises the molten material, and the molten material comprises a reactive component. In at least one embodiment, the molten material may be molten metal. In at least one embodiment, the molten material may be a molten salt. In at least one embodiment, the molten material may be a combination of molten metals, a combination of molten salts or a combination of one or more molten metals and one or more molten salts.

In at least one embodiment, the systems and methods described herein include a reaction process that comprises contacting a feed stream comprising a hydrocarbon with an active metal component within a vessel, reacting the feed stream with the active metal component in the vessel, producing solid carbon based on the reacting of the feed stream with the active metal component in the vessel, contacting the reactive metal component with molten material, solvating at least a portion of the carbon using the molten material, and separating the carbon from the molten material to produce a carbon product.

In at least one embodiment, the systems and methods to produce carbon from a hydrocarbon gas described herein include reactor vessels comprising a molten material, a feed stream inlet to the reactor vessel, a feed stream comprising a hydrocarbon, solid carbon disposed within the reactor vessel, and a product outlet configured to remove the carbon from the reactor vessel. The molten material may include an active metal component and one or more molten metals. The feed stream inlet may be configured to introduce the feed stream into the reactor vessel, and the solid carbon may be a reaction product of the hydrocarbon within the reactor vessel.

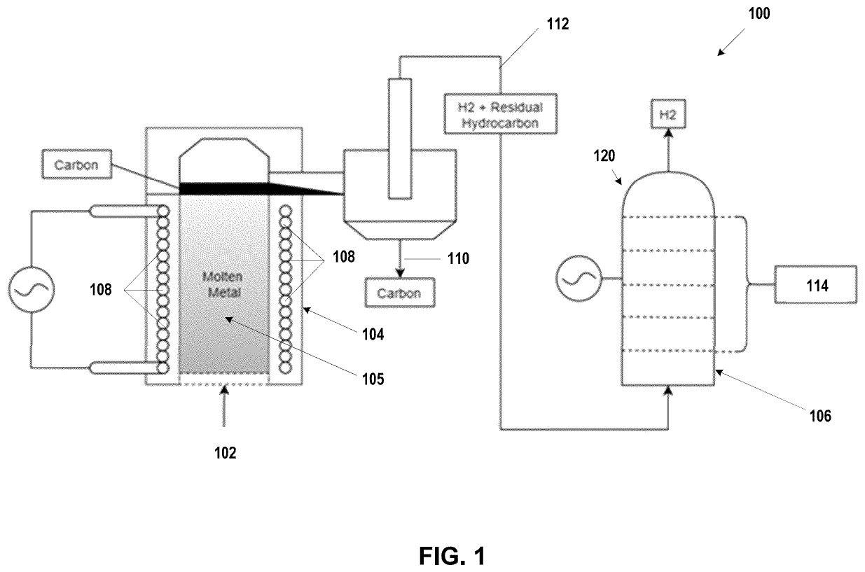

Turning to the figures, one example of a system 100 for generating hydrogen gas is shown schematically in FIG. 1.

In at least one embodiment, the systems include two reaction mechanisms, or stages, operating in series. It should be understood that the term “reactor” or “reactor vessel” is used herein to refer to a vessel housing one or more reaction mechanisms. Each reaction mechanism may be housed in a separate reactor, or each of the reaction mechanisms may be housed within a single reactor vessel. In this case, the single reactor housing the reaction mechanisms has more than one chamber or heat zone therein. It should also be understood that each reaction mechanism may comprise more than one reaction chamber or heat zone.

The reaction mechanisms operate in series and co-operate to decompose a hydrocarbon feed gas, such as but not limited to methane, to achieve thermochemical decomposition of the hydrocarbon feed gas into hydrogen gas and solid carbon in an inert environment (i.e., in the absence of oxygen). This thermochemical decomposition is also referred to as pyrolysis.

The first reaction mechanism is the decomposition of a hydrocarbon feed gas, also referred to herein as a feed stream, comprising a hydrocarbon gas, with a molten metal or salt at elevated temperatures in an oxygen-free environment. The first reaction mechanism may include more than one reaction chamber or heat zone.

The first reaction mechanism is performed in a molten reactor or a molten material reactor, as molten material (e.g., molten metal or molten salt) is used as a heat transfer media to decompose the hydrocarbon feed gas received at the molten reactor. The molten material may have catalytic properties. In at least one embodiment, the reaction is triggered with non-catalytic metal, which can be heated up to the required temperature by the molten reactor.

The first reaction mechanism produces a solid carbon stream and a hydrogen gas stream (that may or may not include residual hydrocarbons and other hydrocarbon gases).

The reaction mechanism can generally be described at equilibrium as proceeding in the first reactor as follows:

$$\\ {CH}_{4} ↔ C ( s ) + 2 {H}_{2} ( g ) ; Δ {H}_{net}^{{}_{} ∘} = + 74.8 kJ / {mol}_{{CH}_{4}}$$

The first reaction mechanism is predicted to proceed at a temperature above 1,000° C. It should be understood that the first reaction mechanism occurs at or below temperatures at which the prior art processes for hydrogen gas production of steam reforming or direct methane decomposition are typically performed.

The second reaction mechanism is the same reaction as is performed as the first reaction mechanism; however, the reaction is completed in a different manner. Where the first reaction mechanism proceeds by contacting a hydrocarbon gas with molten material, in the second reaction mechanism, unconverted hydrocarbons (e.g., methane and/or other hydrocarbon gases) that exit the first reaction mechanism are passed through a heated mesh. The second reaction mechanism is then triggered by micro arcing on a surface (e.g., a serrated surface) of the heated mesh.

Hydrocarbons containing one or more carbon-carbon bonds may be difficult to dissociate, so one or more catalyst metals suitable for cracking alkanes may be required to lower the activation barrier for the first reaction mechanism noted above to occur. Accordingly, in at least one embodiment described herein, the molten material of the first reaction mechanism may include one or more molten catalytic metals that may act as a catalyst for decomposing the hydrocarbon feed gas (e.g., methane) into carbon and hydrogen gas. It should be understood that in these embodiments, the molten metal may therefore comprise a mixture of one or more molten catalytic metals and one or more molten non-catalytic metals as well as salts.

For example, in at least one embodiment, the molten metal may comprise a low melting point metal such as but not limited to gallium (which has a melting point of 29.76° C.), bismuth (which has a melting point of 271.4° C.), tin (which has a melting point of 231.9° C.) or the like as molten non-catalytic metal. It should be understood that the molten non-catalytic metal is typically a low melting point metal (i.e., having a melting point below about 300° C.) and acts as a heat transfer agent within the systems and methods described herein.

For example, in at least one embodiment, the molten metal may also comprise a high melting point metal, also referred to herein as a molten catalytic metal, such as but not limited to nickel (which has a melting point of 1,455° C.), cobalt (which has a melting point of 1,495° C.), iron (which has a melting point in a range of about 1,127° C. to about 1,593° C., depending, for example, if the iron is wrought iron or cast iron) or the like. It should be understood that the molten non-catalytic metal(s) is typically a high melting point metal (i.e., having a melting point above about 1,000° C.).

For example, in at least one embodiment, the molten metal may comprise a mixture of one or more molten catalytic metals and one or more molten non-catalytic metals, also referred to herein as a molten mixture metal as but not limited to any eutectic mixture. The specific composition of the alloys may also influence the catalytic activity. In some embodiments, the components of the molten metal can comprise between 5 mol. % and 95 mol. %, or between 10 mol. % and 90 mol. %, or between 15 mol. % and 85 mol. % of a first component, with the balance being at least one other metal. For example, nickel dissolved in bismuth in the molecular ratio of 0.27:0.73 to maximally lower the melting point of the catalytic metal while achieving maximum methane conversion.

For all types of metal, the temperature required for the decomposition in the first reaction mechanism does not exceed the boiling points of the molten metal (including the boiling points of the molten catalytic metal and the molten non-catalytic metal). In instances where the reaction temperature exceeds the boiling point of the molten metal, the molten metal will start to evaporate, which is undesirable.

Table 1, below, provides the melting point and boiling point of six different metals (three high melting point metals and three low melting point metals) that may be appropriate for molten metal of the first reactor 102.

TABLE 1
Melting and boiling points of various metals

| Metal | Melting Point (° C.) | Boiling Point (° C.) |
|---|---|---|
| Nickel | 1,455 | 2,730 |
| Cobalt | 1,495 | 2,870 |
| Iron | 1,482-1,593 (wrought), | 2,862 |
| | 1,127-1,204 (gray cast), | |
| | 1,149 (ductile) | |
| Tin | 231.9 | 2,602 |
| Bismuth | 271.4 | 1,564 |
| Gallium | 29.76 | 2400 |

In at least one embodiment, the one or more molten catalytic metal may be dissolved in the molten non-catalytic metal to form a molten metal mixture for use in the systems and methods described herein.

Once the first reaction mechanism has been performed and produced the hydrogen gas stream, which may include residual hydrocarbons such as but not limited to residual methane and/or other hydrocarbons, a second reaction mechanism is performed. The second reaction purifies the hydrogen gas stream to produce a purified hydrogen gas (i.e., having negligible residual hydrocarbons).

Each of the first and second reaction mechanisms are each described in greater detail below with reference to the figures.

It should be understood that in the description that follows same reference numbers are used to refer to the same structures in different embodiments of the systems and methods described, where the reference number is increased by 100 for subsequent embodiments.

Referring to FIG. 1, a schematic illustration of a system 100 for generating hydrogen is provided therein. In system 100, a feed stream 102 is provided to a first reactor 104, having a first reaction chamber 105 therein. First reaction chamber 105 houses the first reaction mechanism described above.

First reactor 104 comprises a series of high-frequency solenoid coils 108 surrounding chamber 105. Chamber 105 houses a molten material that reacts with the hydrocarbon feed stream 102 to decompose the hydrocarbons therein. In the embodiment shown in FIG. 1, the high radiofrequency solenoid coils 108 surround chamber 105.

First reactor 104 is configured to direct the hydrocarbons of feed stream 102 to directly interact with the molten material for the decomposition of the hydrocarbons. In the systems and methods described, many different structures are described to facilitate or encourage the interaction of the hydrocarbons of feed stream 102 with the molten metal.

In the first reactor 104, feed stream 102 is directed upwardly through the molten metal. The molten metal is heated by the high-frequency solenoid coils 108, and decomposed carbon is produced at a top portion of chamber 105. Hydrogen gas is also produced and exits chamber 105 at a top portion thereof.

In at least one embodiment, the first reactor 104 may be made of a high temperature and pressure ceramic. Generally, stainless steel is not advisable for first reactor 104 as the molten metal(s) housed therein may corrode the first reactor 104 if it is made of stainless steel.

In other embodiments, first reactor 104 may be made of one or more of titanium and/or Hastelloy, which is a corrosion-resistant nickel alloy that contains other chemical elements such as chromium and molybdenum. Hastelloy typically has high-temperature resistance and exceptional corrosion resistance.

The first reactor 104 produces a carbon product stream 110 and a hydrogen gas product stream 112. Carbon product stream 110 substantially comprises solid carbon generated by the decomposition of the first reaction mechanism. Hydrogen gas product stream 112 comprises hydrogen gas and residual hydrocarbons. A separate vessel may optionally be provided to receive the hydrogen gas and decomposed carbon produced by the first reaction mechanism and separate the hydrogen gas and decomposed carbon into the carbon product stream 110 and the hydrogen gas stream 112.

There are two main mechanisms that can be used to heat the molten material and convert it to a molten state.

A first mechanism relies on eddy currents, where a magnetic field generated by the solenoids induces eddy currents in the material (e.g., metal) to be melted. By using a combination of different solenoids with different currents and at different frequencies, high control of the heating may be achieved.

A second mechanism relies on indirect heating of the material through electric losses in tubes 218 (such as but not limited to tubes 218 comprising one or more refractory metals, hereinafter referred to as “refractory tubes”), or directly on the metal itself. This could be achieved either by running currents directly through the refractory tubes 218 or by inducing surface currents by illuminating tubes 218 with electromagnetic waves. The surface resistance typically depends on the conductor surface resistivity (which in turn depends on conductivity, frequency and conductor thickness and magnetic permeability, as well as temperature).

In at least one embodiment, a combination of both mechanisms may be used. For example, inductive heating may be used to quickly heat up the material (e.g., to its Curie temperature), with surface resistance-based heating being used to bring the material to a specific reaction temperature.

The system also includes a second reactor 106 for receiving hydrogen gas product stream 112, such as at the bottom portion thereof. The second reactor vessel 106 comprises a metal structure or feature for separating the hydrogen gas from the residual hydrocarbons of the hydrogen gas product stream 112. For example, in the example shown as system 100, second reactor 106 includes a heated, serrated metal mesh 114. Hydrogen gas from hydrogen gas product stream 112 passes upwardly through the serrated metal mesh 114, and the residual hydrocarbons of hydrogen product stream 112 are collected thereon.

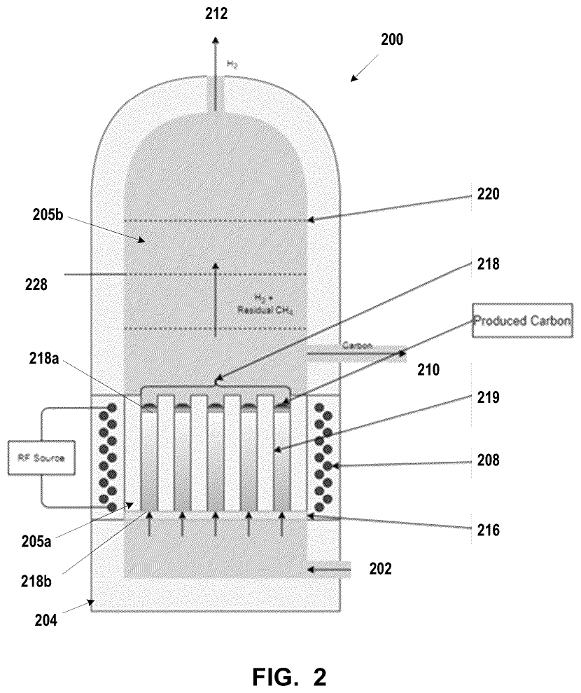

Turning to FIG. 2, shown therein is a system 200 for generating hydrogen according to another embodiment. In system 200, the first reactor 204 has a chamber 205 housing the molten material.

Chamber 205 also comprises a porous plate 216 positioned above where feed stream 202 enters the chamber 205 and below a position of the molten metal therein. Porous plate 216 can also be referred to as a porous distributor. As shown in FIG. 2, the molten material of chamber 205 is housed in an array of metal tubes 218 that are, optionally, formed of ceramic material and referred to as metal tubes for containing the molten material. Porous plate 216 is positioned below the array of tubes 218, optionally immediately adjacent to or abutting a lower end of each of the array of metal tubes 218, and, as the hydrocarbon gas of feed stream, 202 passes therethrough, produces small bubbles along a diameter of each of the metal tubes 218. In at least one embodiment, the production of the bubble may improve decomposition within the first reactor 204. In at least one embodiment, porous plate 216 may be made of quartz. In at least one embodiment, porous plate 216 has a pore size distribution in a range of about 100 to about 300 μm.

In at least one embodiment, the hydrocarbon feed stream 202 may be mixed with, or diluted with, an inert gas such as but not limited to nitrogen or argon. Dilution of the hydrocarbon feed stream 202 may reduce a partial pressure of hydrocarbon gas in a single bubble produced by porous plate 216 as it subsequently travels through along the molten metal. Typically, the first reaction mechanism proceeds at a temperature in a range of about 600° C. to about 1,200° C. Furthermore, it should be understood that the first reaction mechanism typically proceeds at a pressure above atmospheric pressure. However, it should be noted that the decomposition of hydrocarbon gas in the first reaction mechanism may be favoured at a pressure lower than atmospheric pressure. Accordingly, lowering the partial pressure by diluting the hydrocarbon gas of feed stream 102 may improve decomposition. Also, the formation of the bubble increases the gas surface area exposed to the molten metal.

In system 200, initially, the hydrocarbon feed stream 202 is heated to a certain temperature below the reaction temperature, which may be in a range of about 300° C. to about 900° C., for example, using a heat exchanger (not shown). In at least one embodiment, the heat exchanger may be coupled with the reactor products stream (could be from the hot carbon and the hot gasses). The products are expected to have a temperature in a range of about 100 to about 1000° C., and optionally higher than 1000° C.

Reactor 204 has a first reaction chamber 205a and a second reaction chamber 205b generally on top of first reaction chamber 205a. First reaction chamber 205a comprises the aforementioned series of metal tubes 218 housing the molten material. Metal tubes 218 are heated by the high-frequency solenoid 208, such as a radiofrequency (RF) electromagnetic field to the reaction temperature. In at least one embodiment, the RF electromagnetic field region may be in a range of about 1 kHz to about 300 MHz. In at least one embodiment, the RF electromagnetic field region may also include microwaves (i.e., about 300 MHz to about 300 GHz).

Metal tubes 218 are made of a ceramic material forming a sidewall 219 having cylindrical holes therein (not shown) extending between an upper-end 218a and a lower-end 218b. The molten material is positioned within the cylindrical holes. The molten material is heated until it has melted and up to the temperature where decomposition occurs. Upon the heated hydrocarbon gas being in contact with the molten metal, decomposition takes place, producing hydrogen, solid carbon, and other residual hydrocarbons, such as but not limited to acetylene, C₂H₂ ethene, and/or C₂H₄.

In at least one embodiment, the molten material held in tubes 218 may be made of refractory metals, such as but not limited to molybdenum, a titanium-zirconium-molybdenum alloy (TZM), and/or niobium tungsten. A refractory material or refractory is a material that is resistant to decomposition by heat, pressure, or chemical attack. It retains strength and form at high temperatures.

Carbon produced by the decomposition typically floats at the upper-end 218a of the metal tubes 218. It is therefore desirable to remove and/or scrape the carbon away from the metal tubes 218 over time. If the carbon is not removed, the carbon may plug the upper-end 218a of the metal tubes the tubes which could cause major complications.

System 200 also includes a metal structure 220, which acts as a screen to inhibit the passage of carbon into the hydrogen gas product stream 212.

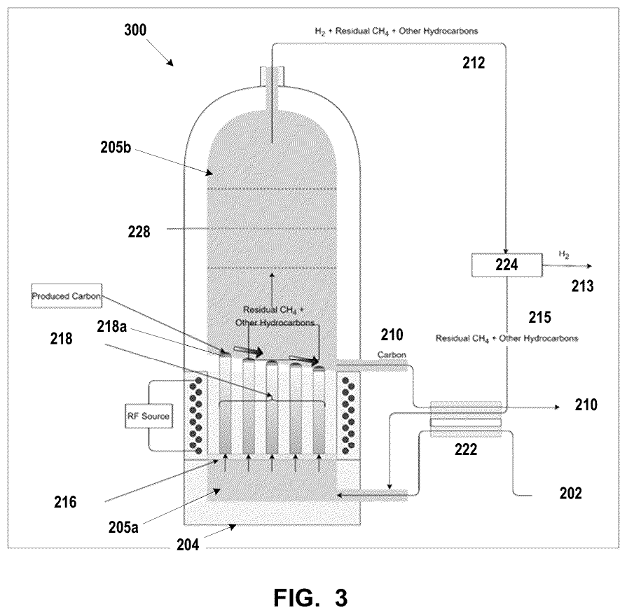

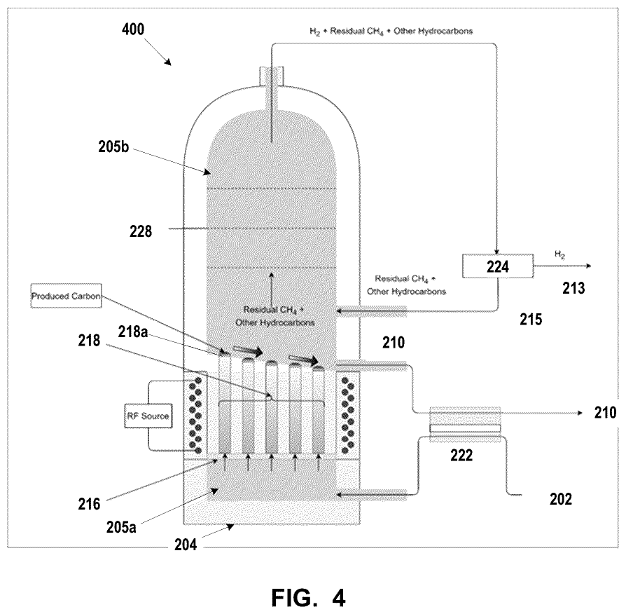

FIG. 3 Error! Reference source not found. and FIG. 4 show systems 300 and 400, respectively, where a top end 218a of each of the metal tubes 218 are arranged to be sloped toward an outlet of the reactor 204 to inhibit the collection of carbon thereon. As the carbon produced floats, the carbon will flow along the slope formed by the top end 218a of each of the metal tubes 218 and will exit the reactor via product stream 210.

Carbon exits the reactor at a temperature in a range of about 100° C. to about 1000° C. In system 300, a heat exchanger 222 is provided that receives carbon product stream 210, removes heat therefrom and provides the heat to hydrocarbon gas stream 202.

Systems 300 and 400 also include a gas separator 224. Hydrogen gas stream 212 is directed to gas separator 224, which separates the stream 212 into hydrogen gas stream 213 and recycles stream 215 comprising residual methane and other hydrocarbons. Recycle stream 215 is directed to heat exchanger 222 and, eventually, mixes with hydrocarbon feed stream 202. In system 400, recycle stream 215 is redirected directly into reactor 204. Gas separator 224 may comprise an adsorbing material that separates hydrogen from the other products. The residual methane and lighter hydrocarbon could be removed by the adsorbing material.

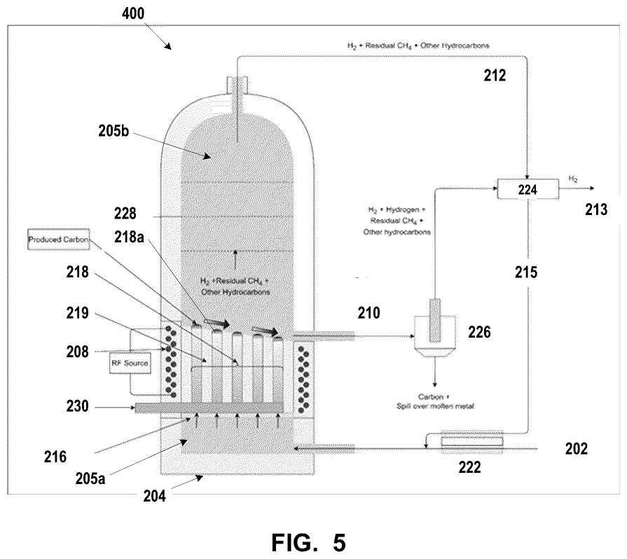

In another embodiment shown in FIG. 5, system 500 also includes a cyclone 224. Carbon product stream 210 is directed to cyclone 226 where residual hydrocarbons, such as but not limited to carbon, some of the molten metal and a portion of the gases therein (e.g. hydrogen, residual hydrocarbons, and other light hydrocarbons) where the carbon and overspilling molten metal will be separated from the gasses.

It should be understood that cyclone 226, or any equipment to separate the gasses and molten metal, may be incorporated within the reactor chamber 204 (after the molten zone and before the metal structures positioned above).

Also, in FIG. 5, a reservoir 230 is shown positioned below the metal tubes 218. Reservoir 230 houses a molten material (e.g., molten metal or molten salt). Reservoir 230 is configured to provide for the molten material therein to flow upwardly into the tubes 218 as the molten material flows upwardly from the tubes 218 outwardly therefrom. In this example, reservoir 230 can provide the volume of molten material within tubes 218 to remain constant over time as the first reaction mechanism occurs.

Gases that exit metal tubes 218 include hydrogen (highest composition), unreacted hydrocarbons (e.g., methane (also known as residual methane)), and the other light hydrocarbons and inert gasses such as nitrogen or argon that may be added initially.

Gases travelling upwardly from metal tubes 218 travel towards one or more heated metal structures 228, where residual methane and other hydrocarbons therein are further be decomposed into hydrogen, carbon, and possibly other hydrocarbons.

Metal structures 228 may include one or more wires, meshes, plates, perforated plates, or the like generally made of one or more catalyzers or coated and/or plated with one or more catalyzers. Product gas from the molten reactor is directed towards one or more metal structures 228.

In at least one embodiment, metal structures 228 may be shaped to maximize a contact area between the metal of the metal structures 228 and the product gas (e.g., the hydrocarbons).

In at least one embodiment, metal structures 228 may be heated by electromagnetic energy. For example, high-frequency currents induced on a surface of the metal structures 228 heat the metal catalyzer(s) of the metal structures 228. In at least one embodiment, a portion of the metal structure 228 having a metal catalyzer may be very thin and may have a high surface resistance, particularly if the catalyzer is deposited of material with relatively low electrical conductivity (e.g., less than 10% of copper). Under such conditions, surface currents will heat the metal structures 228.

In at least one embodiment, as the temperature of the metal structures 228 increases, a resistivity of the metal structures 228 will increase, thereby providing for control of the second reaction mechanism.

In at least one embodiment, metal structure(s) 228 provides at least a portion of residual hydrocarbons present in the product gas stream from the first reactor 204 that did not undergo pyrolysis in the first reactor 204 to undergo pyrolysis and be converted to H₂ and carbon.

It should be understood that metal structure(s) 228 may have any of a variety of configurations. For example, metal structures 228 may include two metal plates spaced apart from each other, having an electric field excited between them. In another example, metal structure 228 may include two metal plates where each plate could have input and output facility and current run through it. Or, in another example, a cavity resonator could be constructed between the plates.

In at least one embodiment, the electromagnetic field built between the plates creates electrical forces acting on each of the plates. By adjusting the mechanical properties of the plates, as well as the frequency of the electromagnetic field and its modulation, one may introduce acoustic waves, typically in the ultrasound range, that can act to clean the surface of the catalyzer from the deposited carbon and thus extend the active life of the catalyzer.

Metal structures 228 are heated to the reaction temperature depending on the type of material used. The heating mechanism can be of various forms, direct electrical heating, induction, convection, microwave, RF, or the like. The gases are further pyrolyzed in the metal structures 228, which may include, for example, a mesh-catalytic reactor.

In at least one embodiment, metal structures 228 are connected to a high-frequency current source, such that the high-frequency produces electrical loss to heat the metal structures 228. In at least one embodiment, the amount of generated heat may be adjusted by adjusting the current strength and/or frequency of the high-frequency current source.

In at least one embodiment, the metal structure 228 includes a serrated edge that promotes micro arcing of gaseous chemicals that pass through and/or over the serrated edge to convert or upgrade the gases into other chemicals, depending on the frequency current.

For the second decomposition to occur, the product gas of the first reaction mechanism contacts the metal structures 228, which may comprise one or more serrated screen surfaces. As noted above, metal structures 228 may be a metal mesh having a mesh size appropriate for the product gas to pass therethrough. The mesh size of the metal structures 228 may impact the conversion of hydrocarbons present in the product stream to hydrogen gas.

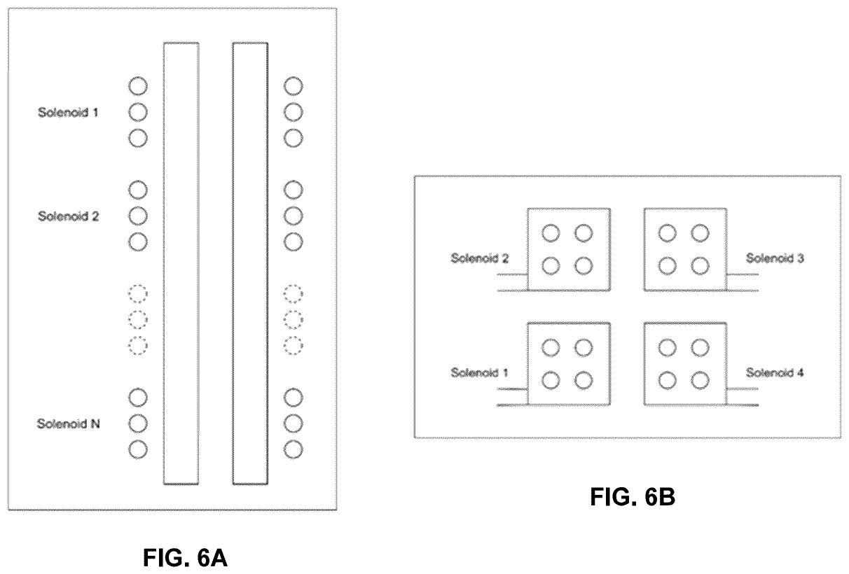

In at least one embodiment, the tubes 218 may be heated using one or more solenoids 208 in a vertical arrangement, such that heat delivery could be controlled vertically. One potential arrangement is shown in FIG. 6A. In at least one embodiment, the tubes 218 may be heated using one or more solenoids 208 in a horizontal arrangement, such that heat delivery could be controlled horizontally. One potential arrangement is shown in FIG. 6B.

The tubes 218 do not have to be heated only by solenoids or eddy currents. In at least one embodiment, a high-frequency current may be run directly through tube 218. This may be particularly advantageous when the tubes 218 are refractor tubes.

In at least one embodiment, the tubes 218 may be made from metals, conductive ceramics (such as but not limited to silicon, carbide, SiC) or graphite.

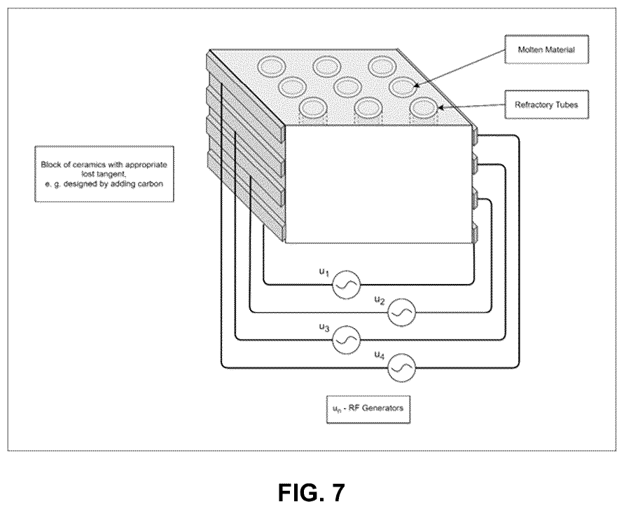

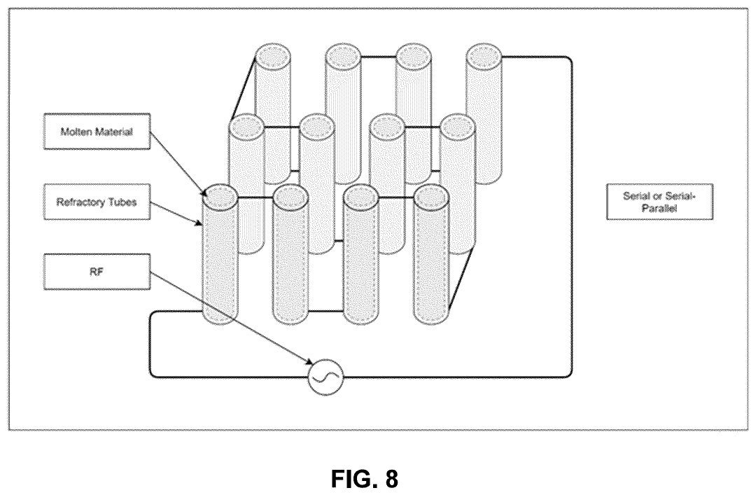

FIGS. 7 and 8 are provided and show exemplary embodiments of arrangements for heating the tubes 218 and molten material therein.

The molten material(s) could be metals, alloys, or intermetallic compounds.

For example, bismuth and nickel form a Bi₃Ni intermetallic compound with a low melting point. These could have catalytic properties to increase reaction efficiency or lead to pyrolysis through temperature.

Other metals may include metals like hafnium, zirconium and yttrium. A combination of metals may also be used, for example, with some materials used as thin protective films over others.

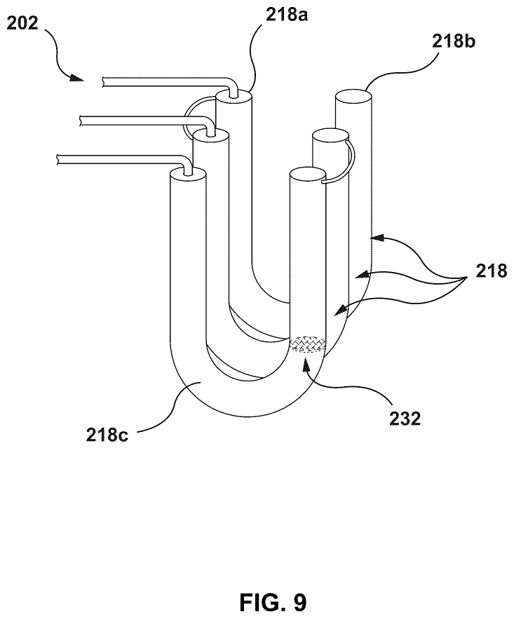

In at least one embodiment, the reactor vessel(s) described herein may be U-shaped to facilitate gas injection from the feed stream into the reactor. An example of this is shown in FIG. 9. In these embodiments, the feed stream 202 may flow downwardly from an upper-end 218a towards an opposite end 218b of a tube 218. In at least one embodiment, a contact area between the gas of feed stream 202 and the molten material within tubes 218 may be increased by extending a length of a horizontal portion 218c of the tubes 218. This may address the challenge of containing the molten metal and still flowing gas in the bottom of tubes 218. In at least one embodiment, a pressure gradient can be included to increase the flow. A filter 232 can be used in the exit arm to keep metal from flawing out of the reactor.

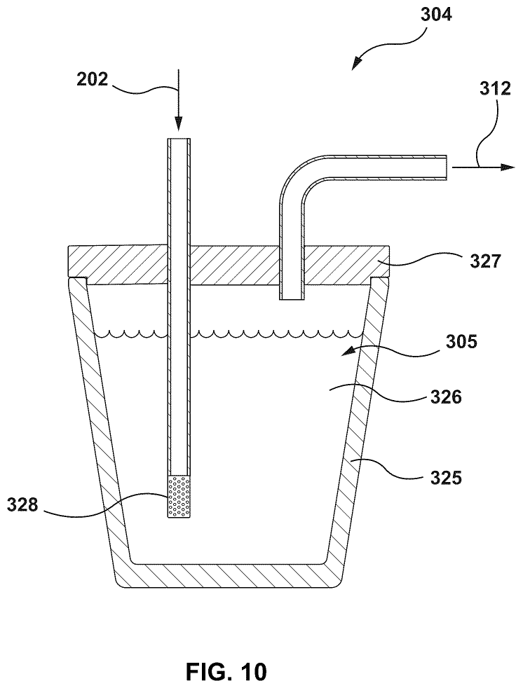

FIG. 10 is a front view of a first reactor vessel 304 of a system for generating hydrogen, according to at least one embodiment described herein. First reactor vessel 304, as shown in FIG. 10, may be included in one or more of the systems and/or methods described herein.

Vessel 304 includes an inlet stream 202 being fed downwardly into a reaction chamber 305 defined by a ceramic crucible 325 and a ceramic lid 327. Reaction chamber 305 houses molten material 326. Hydrogen gas product stream 312 exits the reaction chamber 305 from a top portion thereof. A sintered metal sparger 328 is also included in chamber 305.

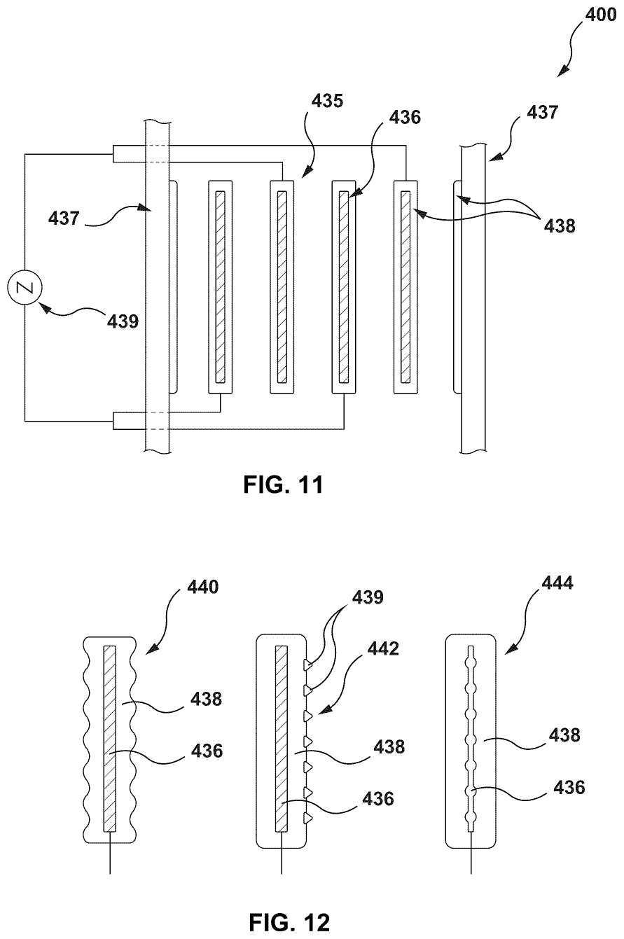

FIG. 11 is a front view of a portion of a third reactor 400 of a system for generating hydrogen, according to at least one embodiment described herein. Third reactor 400 could be introduced to create a micro-arcing field. Third reactor 400 may include one or more electrodes 435 having a metal electrode core 436 and a ceramic outer coating 438 positioned between opposed walls 437 of reactor 400. An electrical source 439 is electrically coupled to each of the electrodes 435 and configured to provide a current to each.

In these embodiments, electric arcs may have very high temperatures that destroy hydrocarbon bonds leading to pyrolysis. Typically, arcs are difficult to control and can lead to reactor damage. Despite that, a whole class of plasma machines are widely used in the industry, typically operating at low pressures and typically at 13.5 MHz, for example, for plasma deposition in the semiconductor industry. Unfortunately, these do not easily translate into H₂ production, where it may be desirable to operate at high pressure. Instead, it may be desirable to utilize a dielectric breakdown mechanism in gas at normal pressure (or above). To facilitate the breakdown and protect electrodes, a high dielectric constant ceramic may be used to cover electrodes. High-temperature materials such as but not limited to alumina (with a dielectric constant of ˜10), zirconia (dielectric constant ˜20), BaSmTi, ZrTi with dielectric constants of about 76 and about 35, respectively, or even super high permittivity materials such TiO₂, BaCaZrTi, BaSrTi, BaTi with a permittivity a range of hundreds may be used.

In at least one embodiment, if the plates of metal structures 228 are arranged such that a dominant electric field is perpendicular to the plates, the electric field will increase upon exiting dielectric material into the space filled with gas by a factor equal to the dielectric constant of the dielectric material. For example, in the case of alumina, the field may increase ten times, which may be enough to create a field strong enough for dielectric breakdown.

In at least one embodiment, a surface of the metal structure 228 may be shaped (e.g., undulated) to concentrate the electric field in specific locations. Three examples of different shapes are shown in FIG. 12. For example, an electrode 440 having a ceramic coating 438 with an uneven surface is shown, an electrode 442 having refracting metal dimples 439 in its ceramic coating is shown, and an electrode 444 having its metal electrode 436 shaped to have varying thicknesses along its length is shown.

For example, refractory metal spikes may also be incorporated to enhance the electric field between plates of the metal structure 228. In these embodiments, arcing may develop in many places between the plates. Since the arc is only created in the space between the plates (e.g., ceramic plates) and does not extend to the electrodes, arcs may generally have small energy and be spawned in multiple locations rather than one (or few) when developed directly between metal electrodes. Further, the electromagnetic signal can be modulated (for example, with on/off envelope) to control overall temperature and arcing conditions and assure varying locations of micro-arcs in the system.

In at least one embodiment, the molten material may comprise gallium. In one study, when the molten material comprised gallium, 91% methane conversion was achieved at 1,119° C. and ambient pressure, with the residence time of the bubbles in the liquid being 0.5 s (Perez, et al., “Methane pyrolysis in a molten gallium bubble column reactor for sustainable hydrogen production: Proof of concept & techno-economic assessment,” International Journal of Hydrogen Energy, 2021, 46:4917-4935).

In at least one embodiment, the molten material may comprise nickel-bismuth, where molten bismuth can dissolve the nickel. In one study, testing various metals dissolved in other metals showed that a mixture with 17% Ni and 83% Bi had the highest hydrogen production rate, with a value of 9.0×10⁻⁸ mol H₂ prod./cm².s. In the same study, a mixture having 27% Ni and 73% Bi is the most active catalyst that achieved the highest methane conversion of 95% at 1,065° C. (Upham, et al., “Catalytic molten metals for the direct conversion of methane to hydrogen and separable carbon,” Science, 2017, 358:917-921).

While the applicant's teachings described herein are in conjunction with various embodiments for illustrative purposes, it is not intended that the applicant's teachings be limited to such embodiments as the embodiments described herein are intended to be examples. On the contrary, the applicant's teachings described and illustrated herein encompass various alternatives, modifications, and equivalents, without departing from the embodiments described herein, the general scope of which is defined in the appended claims.

1. A system for generating hydrogen, the system comprising:
a first reactor configured to receive a feed stream comprising a hydrocarbon gas and produce a pyrolysis product stream comprising hydrogen gas and solid carbon, the first reactor comprising of a series of high-frequency solenoid coils surrounding a first reactor chamber housing a molten material, the first reactor chamber being configured to direct the feed stream through the molten material to convert at least a portion of the hydrocarbon gas to hydrogen gas, carbon and residual hydrocarbons to produce a hydrogen gas product stream and a carbon product stream; and
a second reactor configured to receive the hydrogen gas product stream, the second reactor housing a heated metal structure in a second reactor chamber, the second reactor chamber being configured to direct the hydrogen gas product stream through the heated metal structure to convert at least a portion of the hydrogen gas product stream to hydrogen gas.

2. (canceled)

3. The system of claim 1, wherein:
the reactors operate at a temperature in a range between about 300° C. and 1600° C.; and
the temperature of the hydrogen, carbon and residual hydrocarbons leaving the reactors is in the range of about 300° C. to about 1600° C.

4. The system of claim 1, further comprising utilizing heat generated from the reactors to heat the hydrocarbons gas feed stream entering the pyrolysis generator.

5. The system of claim 4, wherein the hydrocarbon gas feed stream is preheated by the heat generated from the reactors to a temperature in the range of about 300° C. to about 500° C.

6. The system of claim 4, wherein the heat generated from the generators is used to preheat the inlet hydrocarbon gas stream by flowing the hydrocarbon gas into a heat exchanger and flowing the heated hydrogen gas, carbon and residual hydrocarbon gas from the pyrolysis product stream through the heat exchanger to heat the additional incoming gas.

7. The system of claim 1, wherein the hydrocarbon gas is methane or any light hydrocarbon gas.

8. The system of claim 1, wherein the heated hydrogen, carbon and residual hydrocarbon from the hydrocarbon product stream are passed through a gas separator to remove some or all of the carbon produced from the pyrolysis process.

9. The system of claim 1, wherein the first reactor includes at least a metal tube housing the molten material, the metal tube having a lower end and an upper end, the hydrocarbon feed stream passing from the lower end to the upper end.

10. The system of claim 9, wherein the molten material comprises a reactive component comprising a solid disposed within a molten salt mixture, and wherein the active component comprises a metal, a metal carbide, a metal oxide, a metal halide, solid carbon, or any combination thereof.

11. (canceled)

12. (canceled)

13. The system of claim 9, wherein the first reactor includes a series of tubes that are electrically conductive and connected to an electrical source, the electrical source being configured to supply an electrical current to the series of tubes to heat the molten material therein as the hydrocarbon feed stream passes through the molten material.

14. (canceled)

15. The system of claim 13, wherein each tube of the series of tubes comprises a refractory metal or one or more ceramics, the one or more ceramics having either a high loss tangent or being electrically conductive.

16. The system of claim 9, wherein each tube of the series of tubes is arranged so that the upper end of each tube provides for carbon to be entrained by overflowing molten.

17. The system of claim 9, wherein the lower end of the tube is connected to an external source of molten material.

18. The system of claim 1, wherein the second reactor includes a series of metal structures that are electrically conductive and connected to an electrical source or a microwave source or an RF source, the electrical source or the microwave source or the RF source being configured to supply an electrical current and voltage to the series of metal structures to heat the series of metal structures as the hydrogen gas product stream passes through the series of metal structures.

19. The system of claim 18, wherein the metal structures are each a metal mesh comprising one or more high dielectric constant ceramics to promote micro arcing.

20. The system of claim 19, wherein the metal structures are covered with a high dielectric constant ceramic to facilitate dielectric breakdown and protect the metal structure.

21. The system of claim 18 further comprising a series of electrodes arranged such that a dominant electric field is perpendicular to the metal structures and the electrodes are spaced to excite the electric field between them.

22. The system of claim 18, wherein the electrical current is a high-frequency current, such that the high frequency provides enough electrical loss to heat the metal.

23. The system of claim 19, wherein the RF signal is modulated with envelope in acoustic or ultrasound frequency range that induces mechanical vibration between the meshes to clean the surfaces periodically or continuously from the deposited carbon.

24. The system of claim 19, wherein at least a portion of the series of metal meshes comprises one or more surface features to enhance micro-arcing.

25. The system of claim 24, wherein the surface feature is a serrated edge or undulated with varying thickness to concentrate the electric field in specific locations.

26. The system of claim 18, wherein the electrical current is modulated to control overall temperature and arcing conditions and assure varying locations of micro-arcs.

27. (canceled)

28. A method of generating hydrogen, the method comprising:
directing a feed stream comprising methane and/or other hydrocarbons into a first reactor, the first reactor comprising of a series of high-frequency solenoid coils surrounding a first reactor chamber housing a molten metal, the first reactor chamber being configured to direct the feed stream through the molten metal to convert at least a portion of the methane and/or other hydrocarbons to hydrogen gas and residual hydrocarbons to produce a hydrocarbon product stream comprising the hydrogen gas and residual hydrocarbons; and
directing the hydrocarbon product stream into a second reactor, the second reactor being configured to receive the hydrocarbon product stream, the second reactor housing a heated metal structure in a second reactor chamber, the second reactor chamber being configured to direct the hydrocarbon product stream through the heated metal structure to convert at least a portion of the residual hydrocarbons therein to hydrogen gas.
